(19) United States
(12) Patent Application Publication
(10) Pub. No.: US 2007/0163595 A1
(43) Pub. Date: Jul. 19, 2007

(54) Face mask fit on user's head snugly

(76) Inventor: Chun-Nan Chen, Tainan (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/325,201

(22) Filed: Jan. 4, 2006

(51) Int. Cl. A62B 18/02; A62B 18/08

(52) U.S. Cl. 128/207.11; 128/206.21

(57) ABSTRACT

A face mask includes a hollow mask body, a crosswise strap having two ends secured to two sides of the mask body, and a lengthwise strap having a first end secured to an upper portion of the mask body and a second end extended through a mediate portion of the crosswise strap and removably attached to a face of the lengthwise strap. Thus, the crosswise strap and the lengthwise strap form an intersecting face which holds the user's head closely so that the mask body is fit on the user's head snugly to prevent the face mask from slipping from the user's head due to a larger action, such as violent vibration or impact.

### BACKGROUND OF THE INVENTION

1. Field of the Invention

The present invention relates to a face mask and, more particularly, to a face mask that is fit on a user's head snugly to prevent the face mask from slipping from the user's head.

2. Description of the Related Art

A conventional face mask in accordance with the prior art shown in FIGS. 4 and 5 comprises a hollow mask body 2, and a crosswise strap 1 having two ends secured to two sides of the mask body 2. Each of the two sides of the mask body 2 is formed with a snapping hole 21. The crosswise strap 1 has a mediate portion provided with two adjusting members 12 to adjust a length of the crosswise strap 1. Each of the two ends of the crosswise strap 1 is provided with a snapping member 11 snapped into and locked in the respective snapping hole 21 of the mask body 1. In use, when a user pus on the face mask, the length or tension of the crosswise strap 1 is adjusted by the two adjusting members 12, so that the crosswise strap 1 is fit on the back of the user's head.

However, the crosswise strap 1 cannot hold the user's head snugly, so that the crosswise strap 1 is easily movable relative to the user's head due to a larger action, such as violent vibration, impact or jump. Thus, the mask body 2 is easily movable with the crosswise strap 1 to slip from the user's head, thereby causing inconvenience to the user.

### SUMMARY OF THE INVENTION

In accordance with the present invention, there is provided a face mask, comprising a hollow mask body, a crosswise strap having two ends secured to two sides of the mask body, and a lengthwise strap having a first end secured to an upper portion of the mask body and a second end extended through a mediate portion of the crosswise strap and removably attached to a face of the lengthwise strap.

The primary objective of the present invention is to provide a face mask that is fit on a user's head snugly to prevent the face mask from slipping from the user's head.

Another objective of the present invention is to provide a face mask, wherein the crosswise strap and the lengthwise strap form an intersecting face which holds the user's head closely so that the mask body is fit on the user's head snugly to prevent the face mask from slipping from the user's head due to a larger action, such as violent vibration, impact or jump.

A further objective of the present invention is to provide a face mask, wherein the user only needs to place the crosswise strap and the lengthwise strap onto the user's head to attach the mask body to the user's head, so that the face mask is mounted to the user's head easily and rapidly, thereby facilitating the user wearing the face mask.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a face mask in accordance with the preferred embodiment of the present invention.

FIG. 2 is a partially perspective view of the face mask as shown in FIG. 1.

FIG. 3 is a schematic plan operational view of the face mask as shown in FIG. 1 in use.

FIG. 4 is a perspective view of a conventional face mask in accordance with the prior art.

FIG. 5 is a partially perspective view of the conventional face mask as shown in FIG. 4.

### DETAILED DESCRIPTION OF THE INVENTION

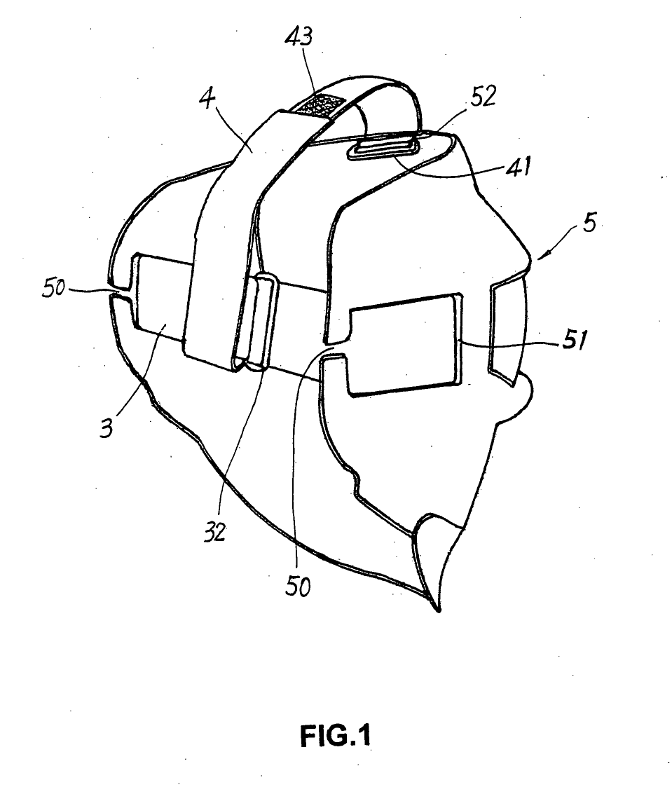

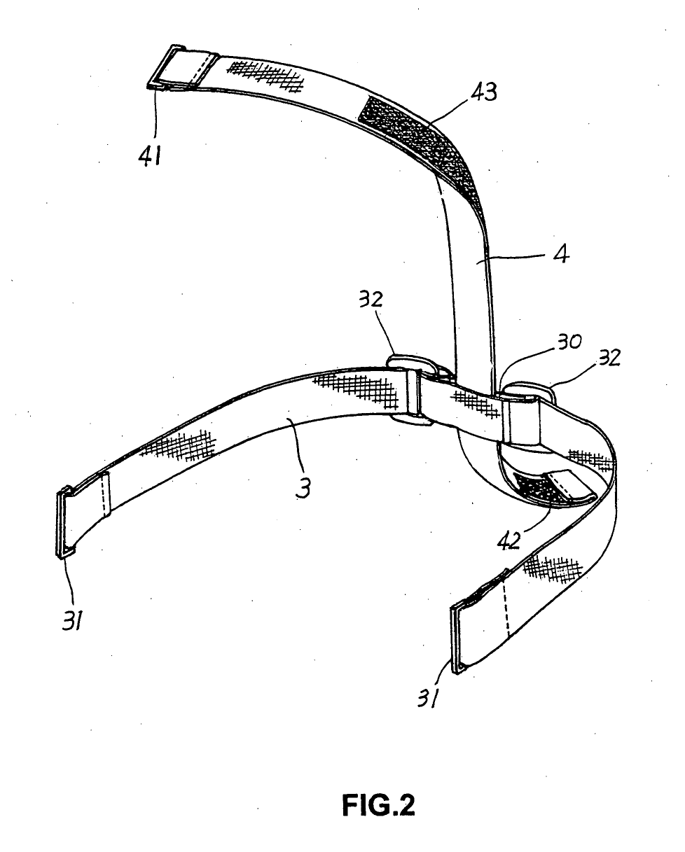

Referring to the drawings and initially to FIGS. 1 and 2, a face mask in accordance with the preferred embodiment of the present invention comprises a hollow mask body 5, a crosswise strap 3 having two ends secured to two sides of the mask body 5, and a lengthwise strap 4 having a first end secured to an upper portion of the mask body 5 and a second end extended through a mediate portion of the crosswise strap 3 and removably attached to a face of the lengthwise strap 4.

Each of the two sides of the mask body 5 is formed with a snapping hole 51, and the upper portion of the mask body 5 is formed with a snapping bore 52. Each of the two sides of the mask body 5 has a rim formed with a slit 50 connected to the snapping hole 51.

The mediate portion of the crosswise strap 3 is provided with two adjusting members 32 to adjust a length of the crosswise strap 3. The mediate portion of the crosswise strap 3 is interposed between the two adjusting members 32 in a staggered manner to form a gap 30 located between the two adjusting members 32 to allow passage of the lengthwise strap 4. Each of the two ends of the crosswise strap 3 is provided with a snapping member 31 snapped into and locked in the respective snapping hole 51 of the mask body 5.

The lengthwise strap 4 intersects the crosswise strap 3. The first end of the lengthwise strap 4 is provided with a snapping member 41 snapped into and locked in the respective snapping bore 52 of the mask body 5. The lengthwise strap 4 has a mediate portion having a face provided with a first bonding member 43, and the second end of the lengthwise strap 4 has a face provided with a second bonding member 42 detachably bonded onto the first bonding member 43 to attach the lengthwise strap 4 to the crosswise strap 3. Preferably, each of the first bonding member 43 and the second bonding member 42 of the lengthwise strap 4 is made of a Velcro. The second end of the lengthwise strap 4 is extended through the gap 30 of the crosswise strap 3 and is bent reversely to pass by a side of the crosswise strap 3.

In assembly, referring to FIGS. 1-3, the snapping member 31 of each of the two ends of the crosswise strap 3 is placed into the respective snapping hole 51 of the mask body 5 through the slit 50. At this time, the snapping hole 51 of the mask body 5 has a width slightly greater than the thickness of the respective snapping member 31 of the crosswise strap 3 and has a length slightly smaller than that of the respective snapping member 31 of the crosswise strap 3, so that the snapping member 31 of each of the two ends of the crosswise strap 3 is placed into the respective snapping hole 51 of the mask body 5 in an oblique manner. Then, the crosswise strap 3 is tightened after placement of the crosswise strap 3 into the respective snapping hole 51, so that the snapping member 31 of each of the two ends of the crosswise strap 3 is returned to an upright state and locked in the respective snapping hole 51 of the mask body 5. Then, the snapping member 41 of the lengthwise strap 4 is snapped into and locked in the respective snapping bore 52 of the mask body 5. Then, the second end of the lengthwise strap 4 is extended through the gap 30 of the crosswise strap 3 and is bent reversely to pass by a side of the crosswise strap 3. Finally, the second bonding member 42 of the lengthwise strap 4 is bonded onto the first bonding member 43 to attach the lengthwise strap 4 to the crosswise strap 3, thereby accomplishing assembly of the face mask.

In such a manner, each of the crosswise strap 3 and the lengthwise strap 4 is made of flexible material, so that each of the crosswise strap 3 and the lengthwise strap 4 has an automatically restoring effect when not subjected to a force, thereby facilitating assembly of the crosswise strap 3 and the lengthwise strap 4 to the mask body 5.

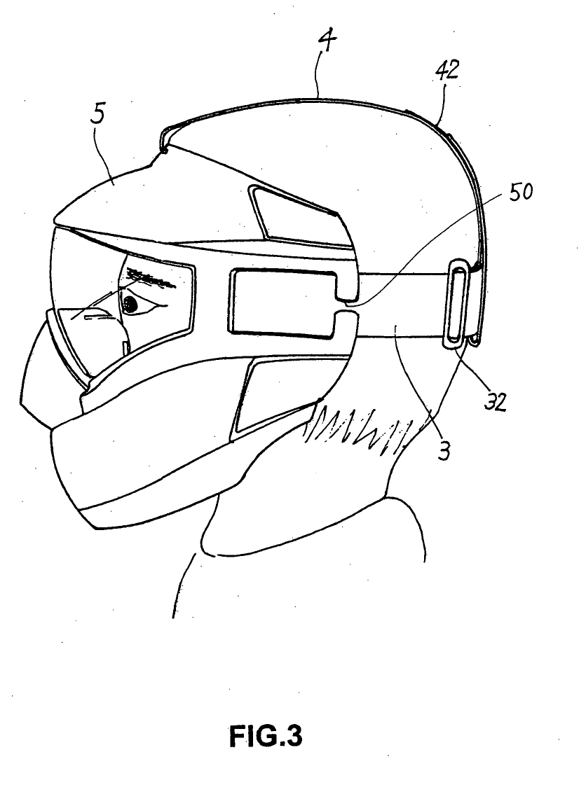

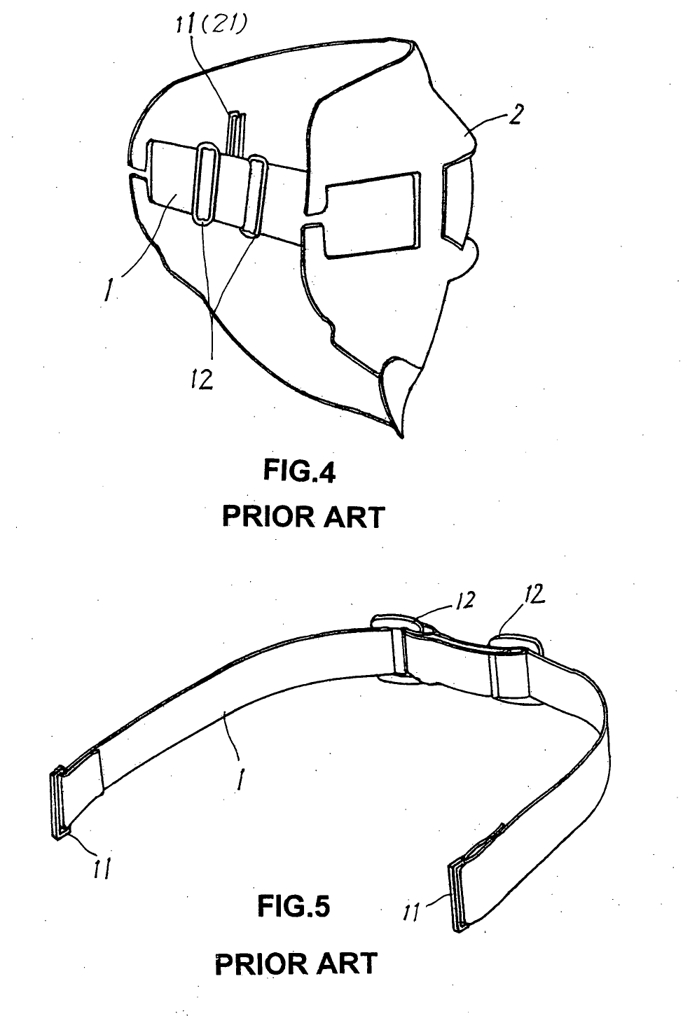

As shown in FIG. 3, when a user pus on the face mask, the length or tension of the crosswise strap 3 is adjusted by the two adjusting members 32, so that the crosswise strap 3 is fit on the back of the user's head closely. Then, the lengthwise strap 4 is pulled outwardly until the lengthwise strap 4 is rested on the top of the user's head closely. Finally, the second end of the lengthwise strap 4 is bent reversely, and the second bonding member 42 of the lengthwise strap 4 is bonded onto the first bonding member 43 to fix the lengthwise strap 4 to the crosswise strap 3, thereby attaching the face mask to the user's head.

Accordingly, the crosswise strap 3 and the lengthwise strap 4 form an intersecting face which holds the user's head closely so that the mask body 5 is fit on the user's head snugly to prevent the face mask from slipping from the user's head due to a larger action, such as violent vibration, impact or jump. In addition, the user only needs to place the crosswise strap 3 and the lengthwise strap 4 onto the user's head to attach the mask body 5 to the user's head, so that the face mask is mounted to the user's head easily and rapidly, thereby facilitating the user wearing the face mask.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A face mask, comprising:
a hollow mask body;
a crosswise strap having two ends secured to two sides of the mask body;
a lengthwise strap having a first end secured to an upper portion of the mask body and a second end extended through a mediate portion of the crosswise strap and removably attached to a face of the lengthwise strap.

2. The face mask in accordance with claim 1, wherein the mediate portion of the crosswise strap is provided with two adjusting members to adjust a length of the crosswise strap.

3. The face mask in accordance with claim 2, wherein the mediate portion of the crosswise strap is interposed between the two adjusting members in a staggered manner to form a gap located between the two adjusting members to allow passage of the lengthwise strap 4.

4. The face mask in accordance with claim 3, wherein the second end of the lengthwise strap is extended through the gap of the crosswise strap and is bent reversely to pass by a side of the crosswise strap.

5. The face mask in accordance with claim 1, wherein the lengthwise strap intersects the crosswise strap.

6. The face mask in accordance with claim 1, wherein the lengthwise strap has a mediate portion having a face provided with a first bonding member, and the second end of the lengthwise strap has a face provided with a second bonding member detachably bonded onto the first bonding member to attach the lengthwise strap to the crosswise strap.

7. The face mask in accordance with claim 1, wherein the upper portion of the mask body is formed with a snapping bore, and the first end of the lengthwise strap is provided with a snapping member snapped into and locked in the respective snapping bore of the mask body.

8. The face mask in accordance with claim 6, wherein each of the first bonding member and the second bonding member of the lengthwise strap is made of a Velcro.

9. The face mask in accordance with claim 1, wherein each of the crosswise strap and the lengthwise strap is made of flexible material

10. The face mask in accordance with claim 1, wherein the crosswise strap and the lengthwise strap form an intersecting face which holds a user's head closely so that the mask body is fit on the user's head snugly to prevent the face mask from slipping from the user's head due to a larger action.
